(19) United States
(12) Patent Application Publication
(10) Pub. No.: US 2026/0145324 A1
(43) Pub. Date: May 28, 2026

(54) CHOLESKY FACTORIZATION METHOD FOR SPARSE MATRICES USING UPPER TRIANGULAR TRANSPOSE SOLVE AND APPARATUS THEREFOR

(71) Applicants: Hyundai Motor Company, Seoul (KR); Kia Corporation, Seoul (KR)

(72) Inventors: JAMAL MUHAMMAD ZAHAK, Hwaseong-Si (KR); Dong Hyun LEE, Hwaseong-Si (KR); Dong Jin HYUN, Hwaseong-Si (KR); Ju Young YOON, Hwaseong-Si (KR)

(21) Appl. No.: 19/215,848

(22) Filed: May 22, 2025

(30) Foreign Application Priority Data
Nov. 26, 2024 (KR) 10-2024-0171388

(51) Int. Cl. B25J 9/16; G06F 17/16

(52) U.S. Cl. CPC B25J 9/1653; G06F 17/16

(57) ABSTRACT

A method performed by an apparatus of a robot may comprise generating an elimination tree of a sparse matrix associated with an autonomous movement operation of the robot, obtaining information related to a pattern of each column of an upper triangular matrix corresponding to the sparse matrix by exploring a reach of the elimination tree, performing, based on the information related to the pattern of each column, numerical decomposition on the sparse matrix using an upper triangular transpose solution, outputting, based on the numerical decomposition on the sparse matrix, a signal, and controlling, based on the signal, the autonomous movement operation of the robot.

### CROSS-REFERENCE TO RELATED APPLICATION

This application claims the benefit of priority to Korean Patent Application No. 10-2024-0171388 filed in the Korean Intellectual Property Office on Nov. 26, 2024, the entire contents of which are incorporated herein by reference.

### FIELD

The present disclosure relates to a Cholesky decomposition method, and more particularly, to a Cholesky decomposition technique for a sparse matrix using an upper triangular transpose solution applicable to a heterogeneous computing system.

### BACKGROUND

A statistical mechanics method of Monte Carlo simulation may be useful in response to a case where degrees of freedom (or number of variables) of a subject are so large that an exact solution cannot be obtained. Subfields or derivatives of statistical mechanics include nonlinear dynamics, chaos theory, plasma physics, thermodynamics, and fluid mechanics. Among the problems in statistical mechanics, simple problems may be solved analytically through the expansion of group terms or approximation methods, but complex problems may be solved numerically through equations or through computer simulations.

Monte Carlo simulations may be applied for solving complex system problems. The Monte Carlo method is a term for an algorithm that uses random numbers to probabilistically determine a value of a function. The method may be used for approximate calculations in response to a case where a value to be computed is not expressed in a closed form or is complex.

Monte Carlo simulation may be used for Cholesky decomposition (or Cholesky factorization), and may be used in various fields such as decomposition of Hermitian matrices and positive-definite matrices.

A result of the Cholesky decomposition may be expressed as a product of a lower triangular matrix and the transpose of a lower triangular matrix.

The Cholesky decomposition may be useful for efficient numerical analysis and may be also usefully applied in Monte Carlo simulations. In particular, the Cholesky decomposition may be used in various practical applications for linear system of equations, and may be about twice as efficient as lower-upper (LU) decomposition because it may utilize the symmetry of matrices and does not require pivoting.

The Cholesky decomposition has many applications, including finding a solution to the equation Ax=b for a given matrix ‘A’ and vector ‘b’, a normal equation for a least-squares problem, discretization of self adjoint partial differential equation boundary value problems, Hessian of convex functions in optimization (in most cases the Hessian is made convex), and systems of equations arising in a primal-dual barrier method for linear programming.

A sparse matrix is a matrix which contains a majority of zeros among its matrix elements, and various types of real-world data. For example, e-commerce purchase history, social network relationships, and inclusion relationships between documents and words, may be stored and utilized in the form of sparse matrices. Artificial intelligence models for sparse matrices, such as recommendation systems and graph neural networks, may be also used.

Robot or vehicle controls are achieved through complex computational logic based on sensing information collected by various sensors. A sparse matrix application may significantly improve the control of the robot or vehicle since sparse matrix techniques provide efficient and fast computations for robot or vehicle control.

### SUMMARY

According to the present disclosure, a method performed by an apparatus of a robot, the method may comprise, generating an elimination tree of a sparse matrix associated with an autonomous movement operation of the robot, obtaining information related to a pattern of each column of an upper triangular matrix corresponding to the sparse matrix by exploring a reach of the elimination tree, performing, based on the information related to the pattern of each column, numerical decomposition on the sparse matrix using an upper triangular transpose solution, outputting, based on the numerical decomposition on the sparse matrix, a signal, and controlling, based on the signal, the autonomous movement operation of the robot.

The method, wherein the information related to the pattern of each column may comprise a column pointer and a row index, wherein the column pointer indicates a starting position of non-zero elements for each column within the upper triangular matrix, and wherein the row index identifies row positions corresponding to the non-zero elements of the upper triangular matrix.

The method, wherein each column value of the upper triangular matrix is determined to generate the upper triangular matrix through the numerical decomposition.

The method, wherein the using the upper triangular transpose solution may comprise, receiving a dense vector corresponding to the sparse matrix, and generating a transpose matrix of the upper triangular matrix, wherein the dense vector is a product of the transpose matrix and another vector.

The method, wherein the performing of the numerical decomposition may comprise determining diagonal component values of the upper triangular matrix, wherein the diagonal component values of the upper triangular matrix are determined based on diagonal component values of the sparse matrix and the other vector.

The method, wherein the upper triangular matrix is generated using the other vector and the diagonal component values of the upper triangular matrix. The method, wherein the reach is obtained by searching for non-zero elements of the sparse matrix. The method, wherein the sparse matrix is a n×n symmetric positive definite matrix, and wherein n is a natural number.

According to the present disclosure, an apparatus may comprise, a processor, and a memory storing at least one instruction that, when executed by the processor communicating with the memory, is configured to cause the apparatus to, generate an elimination tree of a sparse matrix associated with an autonomous movement operation of a robot, obtain information related to a pattern of each column of an upper triangular matrix corresponding to the sparse matrix by exploring a reach of the elimination tree, perform, based on the information related to the pattern of each column, numerical decomposition on the sparse matrix using an upper triangular transpose solution, output, based on the numerical decomposition on the sparse matrix, a signal, and control, based on the signal, the autonomous movement operation of the robot.

The apparatus, wherein the information related to the pattern of each column may comprise a column pointer and a row index, wherein the column pointer indicates a starting position of non-zero elements for each column within the upper triangular matrix, and wherein the row index identifies row positions corresponding to the non-zero elements of the upper triangular matrix.

The apparatus, wherein each column value of the upper triangular matrix is determined to generate the upper triangular matrix through the numerical decomposition.

The apparatus, wherein the at least one instruction, when executed by the processor communicating with the memory, is configured to cause the apparatus to explore the reach of the elimination tree by searching for non-zero elements of the sparse matrix. The apparatus, wherein the sparse matrix is a n×n symmetric positive definite matrix, and wherein n is a natural number.

The apparatus, wherein the at least one instruction, when executed by the processor communicating with the memory, is configured to cause the apparatus to control the autonomous movement operation of the robot, wherein the robot is a quadruped robot, and wherein the control involves performing control of four legs of the quadruped robot.

The apparatus, wherein the at least one instruction, when executed by the processor communicating with the memory, is configured to cause the apparatus to maintain a processing time for the controlling the operation of the robot at fixed intervals.

According to the present disclosure, an apparatus for controlling a vehicle, the apparatus may comprise, a processor, and a memory storing at least one instruction that, when executed by the processor communicating with the memory, is configured to cause the apparatus to, generate an elimination tree of a sparse matrix associated with an autonomous movement operation of the vehicle, determine pattern information for each column of an upper triangular matrix corresponding to the sparse matrix by performing a dependency path traversal of the elimination tree, perform, based on the pattern information, numerical factorization of the sparse matrix using an upper triangular transpose solution, generate, based on the numerical factorization, a signal, and control, based on the signal, the autonomous movement operation of the vehicle.

The apparatus, wherein the signal is generated and applied within a fixed-time interval of 10 milliseconds or less to enable real-time control of the autonomous movement operation of the vehicle.

The apparatus, wherein the at least one instruction, when executed by the processor communicating with the memory, is configured to cause the apparatus to generate the signal based on one or more sensor inputs from the vehicle, wherein the signal is configured to enable control of the vehicle.

The apparatus, wherein the sparse matrix is a symmetric positive definite matrix that represents a control problem formulated using one of a model predictive control framework or a quadratic programming problem for control of the vehicle.

The apparatus, wherein performing the dependency path traversal of the elimination tree may comprise, identifying a set of nodes in the elimination tree corresponding to non-zero entries in a column of the sparse matrix, and traversing upward from the identified set of nodes in the elimination tree to obtain ancestor nodes that represent dependencies for determining a non-zero pattern in a corresponding column of the upper triangular matrix.

### BRIEF DESCRIPTION OF THE DRAWINGS

FIG. 1 shows an example of a Cholesky decomposition method for a sparse matrix according to the related art.

FIG. 2 shows an example of a graphical matrix interpretation of the Cholesky decomposition method for the sparse matrix of FIG. 1.

FIG. 3 shows an example Cholesky decomposition method for a sparse matrix using the proposed method.

FIG. 4 shows an example upper triangular transpose method for sparse Cholesky decomposition.

FIG. 5 and FIG. 6 each shows an example numerical decomposition method.

FIG. 7 shows an example pseudocode according to a Cholesky decomposition algorithm for a sparse matrix.

FIG. 8 shows an example numerical solution process of a Cholesky decomposition method for a sparse matrix.

FIG. 9 shows an example performance of a Cholesky decomposition algorithm.

FIG. 10 shows an example of a device to which a Cholesky decomposition algorithm for a sparse matrix using an upper triangular transpose solution.

FIG. 11 to FIG. 12 show examples of experimental results for comparing performance of the present disclosure with that of a comparative technique.

FIG. 13 shows an example performance of a Cholesky decomposition method.

FIG. 14 shows an example computing apparatus.

### DETAILED DESCRIPTION

Hereinafter, some examples of the present disclosure will be described in detail with reference to exemplary drawings. It should be noted that in adding reference numerals to constituent elements of each drawing, the same constituent elements include the same reference numerals as possible even though they are indicated on different drawings. In describing an example of the present disclosure, when it is determined that a detailed description of the well-known configuration or function associated with the example of the present disclosure may obscure the gist of the present disclosure, it will be omitted.

In describing constituent elements according to an example of the present disclosure, terms such as first, second, A, B, (a), and (b) may be used. These terms are only for distinguishing the constituent elements from other constituent elements, and the nature, sequences, or orders of the constituent elements are not limited by the terms. Furthermore, all terms used herein including technical scientific terms have the same meanings as those which are generally understood by those skilled in the technical field to which an example of the present disclosure pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of factorization method for sparse matrices associated with an operation of the vehicle) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of factorization method for sparse matrices associated with an operation of the vehicle) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of factorization method for sparse matrices associated with an operation of the vehicle) described herein.

Minimum risk maneuver (MRM) operation(s) may also be controlled, for example, based on one or more features (e.g., features of factorization method for sparse matrices associated with an operation of the vehicle) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of factorization method for sparse matrices associated with an operation of the vehicle) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of factorization method for sparse matrices associated with an operation of the vehicle) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

In the present disclosure, vehicle(s) may include robots, aerial vehicles, ground vehicles, underwater vehicles, surface vessels, unmanned vehicles (e.g., unmanned aerial vehicles, unmanned ground vehicles, unmanned underwater vehicles, unmanned surface vessels), robotic vehicles, etc.

Hereinafter, Cholesky decomposition will be briefly described to help understand the present disclosure.

A Cholesky decomposition method is used to factorize a symmetric positive definite sparse matrix into two triangular matrices. This may be expressed in an equation form as shown in following Equation 1.

$${A}^{T} = {LL}^{T} \qquad < Equation 1 >$$

Herein, A indicates a symmetric positive definite sparse matrix, L indicates a triangular matrix, L^{T} indicates a transpose matrix of a lower triangular matrix, which is an upper triangular matrix, L^{T}.

A common problem in computing is to find a numerical value of an ‘x’ vector in an equation, as in Equation 2 below.

$$b = Ax \qquad < Equation 2 >$$

Herein, A denotes a symmetric positive definite sparse matrix for a Cholesky method, and ‘x’ and ‘b’ indicate vectors.

In response to using Cholesky decomposition, a sparse matrix A is split into two matrices—an upper triangular matrix and a lower triangular matrix—as shown in Equation 3 below, according to Equation 1.

$$b = ( {LL}^{T} ) x \qquad < Equation 3 >$$

By applying a method of Equation 3, an algorithm has a faster solution process.

$$In A = {LL}^{T} in response to a case where A = [ \begin{matrix}{a}_{11} & {a}_{12} & {a}_{13} & {a}_{14} \\ {a}_{21} & {a}_{22} & {a}_{23} & {a}_{24} \\ {a}_{31} & {a}_{32} & {a}_{33} & {a}_{34} \\ {a}_{41} & {a}_{42} & {a}_{43} & {a}_{44}\end{matrix} ] ,$$

after the split,

$$it may be expressed as A = [ \begin{matrix}{l}_{11} & 0 & 0 & 0 \\ {l}_{21} & {l}_{22} & 0 & 0 \\ {l}_{31} & {l}_{32} & {l}_{33} & 0 \\ {l}_{41} & {l}_{42} & {l}_{43} & {l}_{44}\end{matrix} ] [ \begin{matrix}{l}_{11} & {l}_{21} & {l}_{31} & {l}_{41} \\ 0 & {l}_{22} & {l}_{32} & {l}_{42} \\ 0 & 0 & {l}_{33} & {l}_{43} \\ 0 & 0 & 0 & {l}_{44}\end{matrix} ] .$$

For example, the split matrix described above may be used to solve a linear system of equations such as Equation 4 below.

$${a}_{11} {x}_{1} + {a}_{12} {x}_{2} + {a}_{13} {x}_{3} = {b}_{1} \qquad < Equation 4 >$$

$${a}_{21} {x}_{1} + {a}_{22} {x}_{2} + {a}_{23} {x}_{3} = {b}_{2}$$

$${a}_{31} {x}_{1} + {a}_{32} {x}_{2} + {a}_{33} {x}_{3} = {b}_{3}$$

$$or$$

$$[ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ] [ \begin{matrix}{x}_{1} \\ {x}_{2} \\ {x}_{3}\end{matrix} ] = [ \begin{matrix}{b}_{1} \\ {b}_{2} \\ {b}_{3}\end{matrix} ]$$

it may be expressed as Ax=b, where the purpose of the division is to obtain a vector ‘x’ from the given “A” and “b” Ax=b In response to a case where the split A is applied, LL^{T}x=b and x may be obtained through a lower triangle solution method using a forward elimination method Ly=b or an upper triangle solution method using a backward elimination method L^{T}x=y

As a result, the simultaneous equations may be solved through following series of mathematical development processes.

$$Ax = b$$

$${L}^{T} x = b$$

$${U}^{T} Ux = b$$

$${U}^{T} y = b ( Lower Triangular solve using forward elimination )$$

$$Ux = y ( Upper Triangular solve using backward elimination )$$

Hereinafter, to help understand the present disclosure, a concept of sparse matrices will be briefly described.

A sparse matrix indicates a matrix in which most of the values are 0, unlike a data structure of a dense matrix.

A fastest way to handle sparse matrices is to define a data structure with six main data members. Herein, the primary data members may include column pointers, row indices, values, No. of columns, No. of rows, and No. of non-zero values. For example, a column pointer is an array that indicates a starting index of each column's non-zero entries within a row index and value arrays. For example, a row indices is an array that stores row positions of non-zero values, column by column. For example, a matrix A below is a sparse matrix, with 50% of its values being 0.

$$A = [ \begin{matrix}4.5 & 0 & 3.2 & 0 \\ 0 & 2.9 & 0 & 0.9 \\ 0 & 1.7 & 3. & 0 \\ 3.5 & 0 & 0 & 1.\end{matrix} ]$$

Herein, a data structure of the matrix A is as follows.

Column pointer: Ap=[0 2 4 6 8], which means:
0: column 0 of Ap starts at index 0 and ends at index 1 (for two non-zero entries, 4.5 and 3.5 in the 0^{th} column),
2: column 1 of Ap starts at index 2 and ends at index 3 (for two non-zero entries, 2.9 and 1.7 in the 1^{st} column),
4: column 2 of Ap starts at index 4 and ends at index 5 (e.g., for two non-zero entries, 3.2 and 3.0 in the 2^{nd} column), and
6: column 3 of Ap starts at index 6 and ends at index 7 (e.g., for two non-zero entries, 0.9 and 1.0 in the 3^{rd} column).

Row indices: Ai=[0 3 1 2 0 2 1 3], which indicates row positions of the non-zero entries, column by column:
0: a value of column 0 of Ai indicates that non-zero entry “4.5” is at 0^{th} row
3: a value of column 1 of Ai indicates that non-zero entry “3.5” is at 3^{rd} row
1: a value of column 2 of Ai indicates that non-zero entry “2.9” is at 1^{st} row
2: a value of column 3 of Ai indicates that non-zero entry “1.7” is at 2^{nd} row
0: a value of column 4 of Ai indicates that non-zero entry “3.2” is at 0^{th} row
2: a value of column 5 of Ai indicates that non-zero entry “3.0” is at 2^{nd} row
1: a value of column 6 of Ai indicates that non-zero entry “0.9” is at 1^{st} row
3: a value of column 7 of Ai indicates that non-zero entry “1.0” is at 3^{rd} row
Values: Ax=[4.5 3.5 2.9 1.7 3.2 3.0 0.9 1.0],
No. of columns: n_col=4
No. of rows: n_rows=4
No. of non-zero values: n_nz=8

Hereinafter, a Cholesky decomposition method for dense matrices will be briefly described.

As shown in Equation 5 below, it is assumed that A is an N by N symmetric positive definite matrix that is factorized into L and L^{T}

$$A = {LL}^{T} \qquad < Equation 5 >$$

At each iteration of the algorithm, Equation 5 may be decomposed in a same way as following Equation 6.

$$[ \begin{matrix}{A}_{11} & {a}_{12} \\ {a}_{12} & {a}_{22}\end{matrix} ] = [ \begin{matrix}{L}_{11} & 0 \\ {{l}^{T}}_{12} & {L}_{22}\end{matrix} ] [ \begin{matrix}{{l}^{T}}_{11} & {L}_{12} \\ 0 & {L}_{22}\end{matrix} ] \qquad < Equation 6 >$$

Herein, A11 is a (N−1)×(N−1) matrix, L11 is a (N−1)×(N−1) matrix, and a₁₂^{T} is a t 1×(N−1) vector, and l₁₂^{T} is a 1×(N−1) vector, and a₂₂ is a scalar at position N×N, and l₂₂ is a scalar at position N×N. In the instant case, N is 2.

From Equation 6, following three equations may be derived.

$${A}_{11} = {L}_{11} {L}_{11}^{T}$$

$${a}_{11} = {L}_{11} {l}_{11}$$

$${l}_{22} = \sqrt{{a}_{22} - {l}_{12}^{T} {l}_{12}}$$

In detail, by applying recursive factorization to the leading submatrix A, it may be expressed as an equation

$${A}_{11} = {L}_{11} {L}_{11}^{T} .$$

Herein, the above equation is a recursive equation that evaluates L by traversing N columns of the matrix A. A trigonometric solution for a₁₂ with non-diagonal entries is denoted by a₁₂=L₁₁l₁₂, which is a lower trigonometric solution problem that uses 112 to evaluate each column of L in response to a case where a₁₂ entries are known. A dot product for the diagonal entry l₂₂ may be expressed as

$${l}_{22} = \sqrt{{a}_{22} - {l}_{12}^{T} {l}_{12}} ,$$

and finally, a diagonal entry l₂₂ of L may be determined from the above equation.

A MATLAB function for the above-described algorithm (also known as “Up Looking Cholesky Factorization Method”) may be coded as follows:

```
function L = cholup(A)
  n = size(A);
  L = zeros(n);
  for k = 1:n
    L(k, 1:k−1) = (L(1:k−1,1:k−1) \ A(1:k−1,k))’;
    L(k,k) = sqrt(A(k,k) − L(k,1:k−1) * L(k,1:k−1)’);
  end
```

A Cholesky decomposition for sparse matrices according to the present disclosure may also be implemented with a same idea as the algorithm described above.

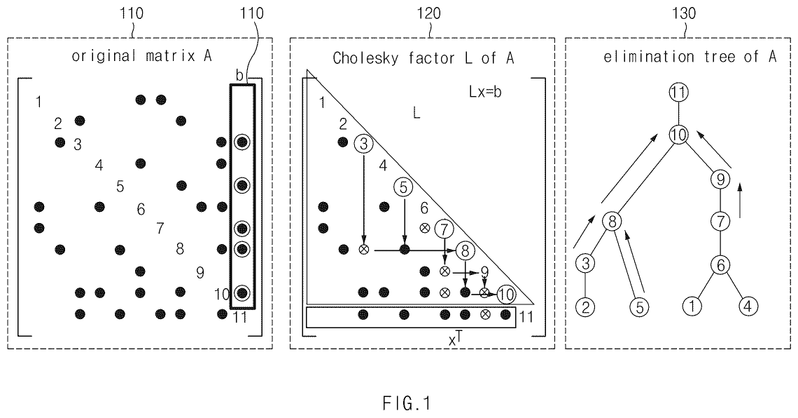

Hereinafter, differences between the related art and the present disclosure in the Cholesky decomposition method for sparse matrices will be described in detail with reference to FIGS. 1 to 12.

FIG. 1 shows an example of a Cholesky decomposition method for a sparse matrix according to the related art.

The Cholesky decomposition method for sparse matrices includes the following four main steps.
1. Generating the ‘elimination tree’
2. Determining the ‘reach’ of the tree for the pattern of each column of the matrix
3. Determining the number of column counts
4. Performing the numeric factorization

For example, the Cholesky decomposition method for existing sparse matrices starts by finding the reach of the elimination tree of A to find a pattern in each column of ‘L’, and then finds a pattern in each column of L. In particular, the existing Cholesky decomposition method for sparse matrices had the disadvantage of having to perform several additional steps, including finding a number of column counts, to evaluate the pattern of L in advance before performing numerical decomposition (e.g., in sparse matrix solvers for engineering simulations, real-time controllers, or optimization problems, etc.). Referring to FIG. 1, reference numeral 110 indicates the original matrix A with numbers of 11 rows and 11 columns.

Referring to reference numerals 110 and 120, x may be computed from a lower triangular matrix L, which is a Cholesky factor of the matrix A, and the dense vector b(111). For example, in response to finding non-zero values 122 in an 11^{th} row of L—i.e., non-zero pattern—, this may be done through pattern analysis of columns 3, 5, 7, 8, and 10 of L and numerical decomposition based on an elimination tree of A, as pointed by reference numbers 120 and 130 (e.g., to analyze sparsity patterns in matrices arising from finite element analysis, structural simulations, or robotic control problems, etc.).

The elimination tree is a special graph structure for square symmetric matrices that represents a way to maintain a structure of a matrix while eliminating certain elements of the matrix. In the MATLAB, an elimination tree using an etree function may be computed, and the etreeplot function of the MATLAB may be used to visually represent the elimination tree, as shown with reference numeral 130.

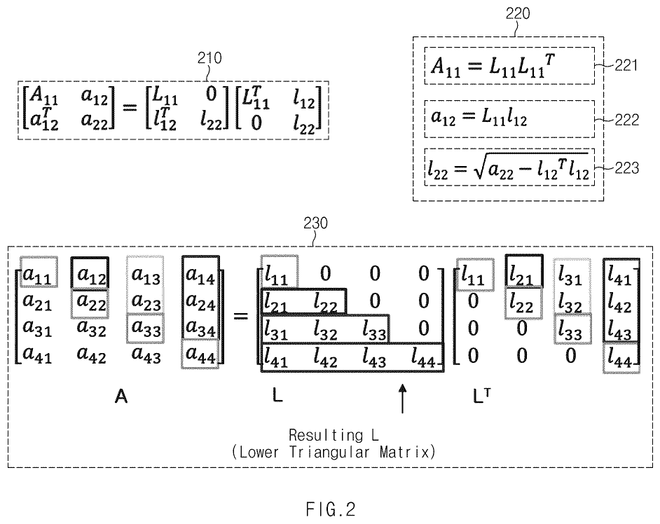

FIG. 2 shows an example of a graphical interpretation of the Cholesky decomposition method for the sparse matrix of FIG. 1.

Referring to FIG. 2, as shown in the formula of reference numeral 220, a leading submatrix (or principal submatrix) A₁₁ of a positive definite matrix A may be obtained through recursive factorization using a formula of reference numeral 221 of reference numeral 210. Herein, a leading submatrix A of the n×n matrix A may be selected from a set I⊂[1, 2, . . . , n] and obtained by deleting all rows and columns whose indices are not I.

For example, the leading submatrix A_{[2,4]} corresponding to a set {2, 4} in the 4×4 matrix A below may be expressed as follows (e.g., used in solving sub-problems in block-decomposition methods, optimization problems, or predictive control systems, etc.).

$$A = [ \begin{matrix}{a}_{11} & {a}_{12} & {a}_{13} & {a}_{14} \\ {a}_{21} & {a}_{22} & {a}_{23} & {a}_{24} \\ {a}_{31} & {a}_{32} & {a}_{33} & {a}_{34} \\ {a}_{41} & {a}_{42} & {a}_{43} & {a}_{44}\end{matrix} ] , {A}_{[ 2 , 4 ]} = [ \begin{matrix}{a}_{22} & {a}_{24} \\ {a}_{42} & {a}_{44}\end{matrix} ]$$

Furthermore, through an interaction formula shown in reference numeral 210, as shown in reference numeral 222 of reference numeral 220, the non-diagonal entry l₁₂ of the upper triangular matrix L^{T} may be computed by a formula of reference numeral 222, and the diagonal entry of the upper triangular matrix L^{T} may be computed by a formula of reference numeral 223.

Reference numeral 230 in FIG. 2 shows a graphical interpretation of the Cholesky decomposition for the 4×4 matrix A, and a MATLAB code below is a function that generates the upper triangular matrix of the n×n matrix A according to the algorithm in FIG. 2 (e.g., a function using backward substitution with sparse patterns for faster computation, etc.).

```
function L = cholup(A)
  n = size(A);
  L = zeros(n);
  for k = 1:n
    L(k,1:k−1) = (L(1:k−1,1:k−1) \ A(1:k−1,k))’;
    L(k,k) = sqrt(A(k,k) − L(k,1:k−1) * L(k,1:k−1)’);
  end
```

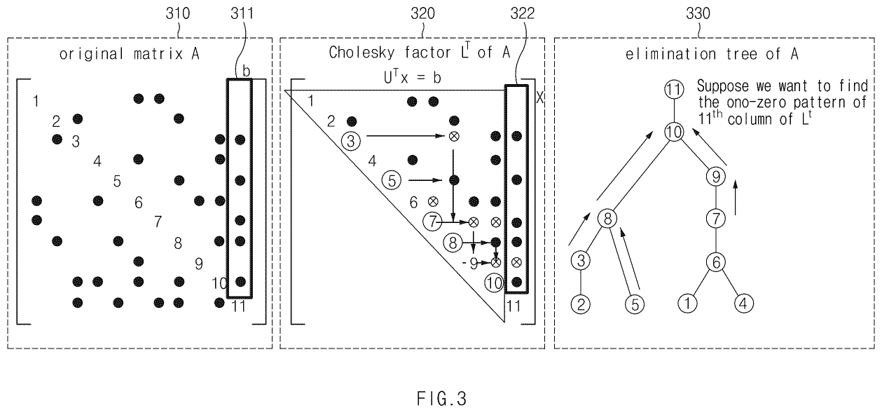

FIG. 3 shows an example Cholesky decomposition method for a sparse matrix.

Referring to reference numerals 310 and 320, the solution vector x may be computed from the upper triangular transpose matrix U^{T} 222, which is a Cholesky factor of the matrix A, and the dense vector b 311. That is, x may be computed through an equation U^{T}x=b. For example, in response to finding non-zero values (322) in a 11^{th} column of L^{T}—i.e., non-zero pattern—as shown in reference numerals 320 and 330, the pattern in the 11^{th} column of L^{T} may be expressed by a following equation below.

$${L}_{i 11} = [ 3 , 5 , 7 , 9 , 10 , 11 ] or alternatively , \\ {L}_{i , 11} \neq 0 for i = 3 , 5 , 7 , 8 , 9 , 10 , 11 , etc . )$$

The elimination tree is a special graph structure for square symmetric matrices that represents a way to maintain a structure of a matrix while eliminating certain elements of the matrix. In the MATLAB, an elimination tree using an etree function may be computed, and the etreeplot function of the MATLAB may be used to visually represent the elimination tree, as shown with reference numeral 330 (e.g., to optimize memory allocation during sparse factorization, to reduce fill-in, or to precompute sparse matrix patterns, etc.).

Particularly, the Cholesky decomposition method for a sparse matrix according to the present disclosure has advantage of reducing complexity of the Cholesky decomposition and providing a faster sparse matrix algorithm by eliminating the step for evaluating the column pointer matrix in the method of FIGS. 1 and 2—that is, the step of finding the number of column counts.

For this purpose, the Cholesky decomposition method for sparse matrices according to the present disclosure may include operations of generating an elimination tree for L^{T} and finding a reach of the elimination tree to find a pattern in L^{T}. Specifically, a proposed method may use the reach of the elimination tree, indicated by the arrow in reference numeral 330, to compute a pattern of each column of L^{T} (e.g., in symbolic analysis prior to numerical factorization, or to reduce computation time in robotics or real-time embedded systems, etc.).

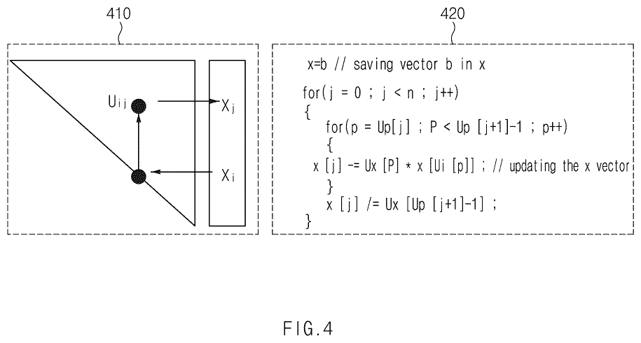

FIG. 4 shows an example upper triangular transpose method for sparse Cholesky decomposition.

As described in the FIG. 3, in response to a case where an upper triangular matrix U and a dense vector b are given, the vector x may be computed through the interaction formula U^{T}x=b.

The reference numeral 410 may be a process map for transposition U^{T}. Herein, evaluation may start from an i^{th} element of x and proceeds to a j^{th} element (e.g., processing from bottom to top in the column due to the upper triangular structure, etc.).

Reference numeral 420 may be an example of implementing the interaction formula U^{T}x=b for computing vector x in a MATLAB code (e.g., using loop-based backward substitution or vectorized operations, etc.).

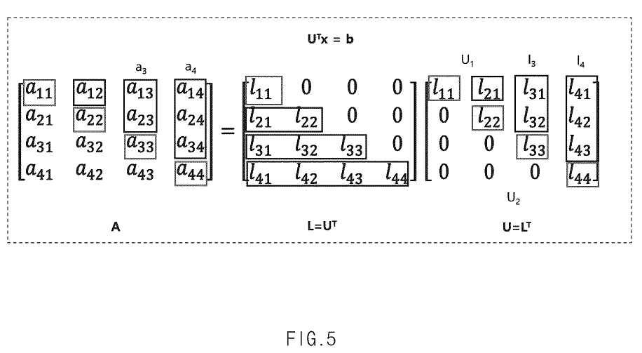

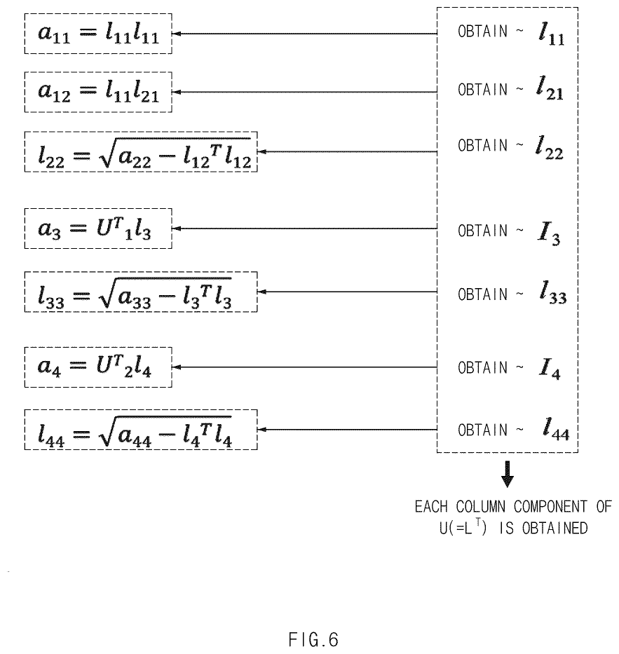

FIG. 5 and FIG. 6 each shows an example numerical decomposition method.

Referring to FIG. 5, the Matrix A may be expressed as a matrix product of the lower triangular matrix L and the upper triangular matrix L^{T}, which are Cholesky factors. Herein, L may be expressed as an upper triangular transpose matrix U^{T}, and L^{T} may be expressed as U.

In the instant case, each column including diagonal elements and/or off-diagonal elements of the upper triangular matrix U may be computed by sequentially applying equations shown in reference numerals 610 to 670 of FIG. 6. That is, the Cholesky decomposition for a sparse matrix according to the present disclosure may be a numerical decomposition in which an upper triangular transpose solution method may be applied to find each column element of the upper triangular matrix L^{T} (e.g., to reduce fill-in, enable parallel computation, or improve cache efficiency, etc.).

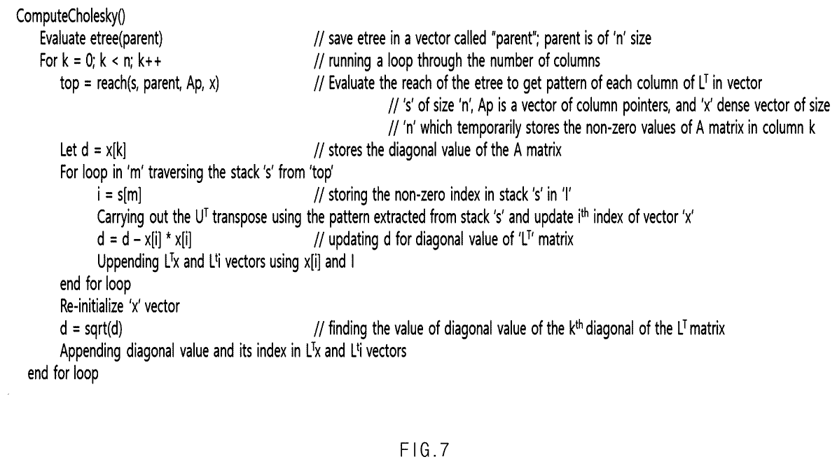

FIG. 7 shows an example pseudocode according to a Cholesky decomposition algorithm for a sparse matrix.

Specifically, FIG. 7 illustrates a pseudocode written in C++ implementing a Cholesky decomposition algorithm of the symmetric positive definite matrix A described above (e.g., to compute sparse Cholesky factors for robotics, scientific simulations, or embedded optimization tasks, etc.).

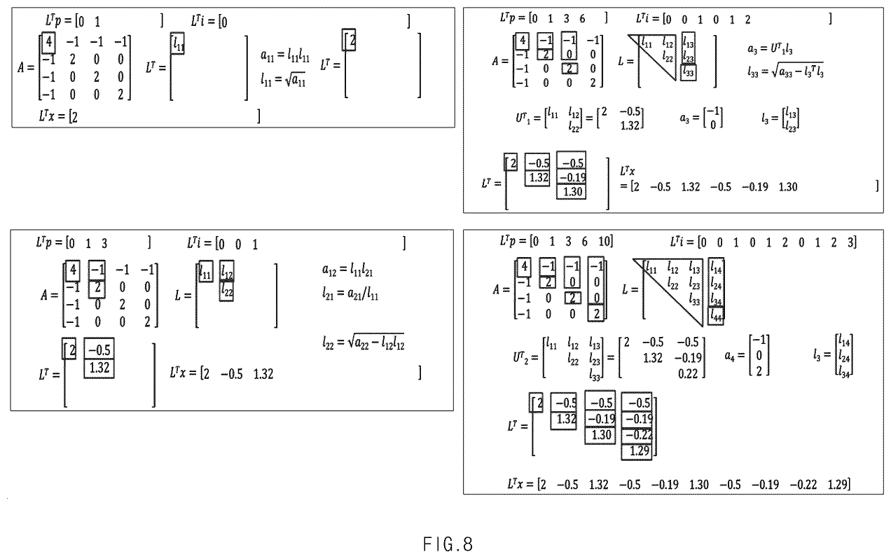

FIG. 8 shows an example numerical solution process of a Cholesky decomposition method for a sparse matrix.

In the present example, taking

$$A = [ \begin{matrix}4 & - 1 & - 1 & - 1 \\ - 1 & 2 & 0 & 0 \\ - 1 & 0 & 2 & 0 \\ - 1 & 0 & 0 & 2\end{matrix} ]$$

as an example, the Cholesky decomposition procedure for a sparse matrix according to the present disclosure will be described in detail.

Column points of A A_{P}=[0 4 6 8 10], Row indices of A with non-zero values Aᵢ=[0 1 2 3 0 1 0 2 0 3], and non-zero component values of A Aₓ=[4 −1 −1 −1 −1 2 −1 2 −1 2] (e.g., as in compressed sparse column (CSC) format for memory-efficient storage in matrix libraries such as Eigen, SuiteSparse, or CXSparse, etc.).

L^{T}p and L^{T}i values may be obtained in advance by a method of finding the reach described above.

Referring to reference numeral 810, a first column l₁₁ of the upper triangular matrix L^{T} may be computed according to a formula of reference numeral 610 of the FIG. 6. In the present example, it may be computed as l₁₁=2(a₁₁=l₁₁l₁₁l₁₁−\sqrt{a₁₁}).

Referring to reference numeral 820, second columns l₂₁ and l₂₂ of the upper triangular matrix L^{T} may be computed according to formulas of reference numerals 620 and 630. In the present example, l₂₁ and l₂₂ may computed as −0.5 and 1.32 respectively (e.g., after subtracting accumulated squares from diagonal elements, then taking the square root, etc.).

Referring to reference numeral 830, third columns l₃₁, l₃₂ and l₃₃ of the upper triangular matrix L^{T} may be computed by applying the upper triangular transpose solution according to the formulas of the reference numerals 640 and 650. In the present example, l₃₁, l₃₂ and l₃₃ may be computed as −0.5, −0.19 and 1.30 respectively.

Referring to reference numeral 840, fourth columns l₄₁, l₄₂, l₄₃ and l₄₄ of the upper triangular matrix L^{T} may be computed by applying the upper triangular transpose solution according to the formulas of the reference numerals 660 and 670. In the present example, l₄₁, l₄₂, l₄₃ and l₄₄ may be computed as −0.5, −0.19, −0.22, and 1.29 respectively (e.g., following backward substitution while accounting for already computed upper triangular values, etc.).

Hereinafter, performances of algorithms according to the related art and the present disclosure are compared.

The Cholesky decomposition method according to the related art consists of the following four steps:
1. Finding out the ‘elimination tree’ (Complexity: O(|A|))
2. Finding out the ‘reach’ of the tree for the pattern of each column of the matrix (Complexity: O(|L|))
3. Finding out the number of column counts (extra step) (Complexity: O(N))
4. Carrying out the numeric factorization (Complexity: O(|L|))

The Cholesky decomposition method according to the present disclosure may include following three operations:
1. Finding out the ‘elimination tree’ (Complexity: O(|A|))
2. Finding out the ‘reach’ of the tree for the pattern of each column of the matrix (Complexity: O(|L|))
3. Carrying out the numeric factorization (Complexity: O(|L|))

Herein, |A| indicates a number of non-zero values in the matrix A, |L| indicates a number of non-zero values in the upper triangular matrix L^{T}, and N indicates a number of columns in matrix A (e.g., for a 100×100 sparse matrix used in the experimental tests shown later, etc.).

The Cholesky method according to the present disclosure may reduce algorithmic complexity by eliminating the step of finding the reach of an elimination tree for evaluating the pattern of each column of the upper triangular matrix. Accordingly, it provides the advantage of faster and more efficient sparse matrix decomposition (e.g., suitable for real-time control loops in robotics, embedded optimization in autonomous vehicles, or matrix solvers for scientific computing, etc.)

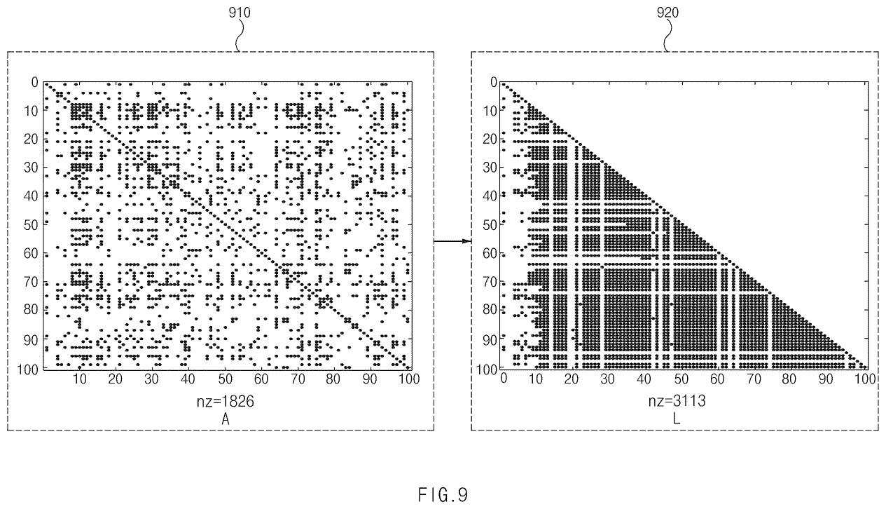

FIG. 9 shows an example performance of a Cholesky decomposition algorithm.

This experiment was performed on an Intel Core i-5 @ 2.4 GHz×8 core PC with Ubuntu 20.04.6 LTS OS to compare the proposed disclosure with the existing CXSparse Library and Eigen Sparse Library.

In experimental results below, Tables 1 to 6 present non-real time results, and Tables 7 to 9 present real time results.

A proposed algorithm according to the present disclosure was tested on two different systems—one targeting for real time and another targeting for non-real time environments to to evaluate performance across diverse use cases (e.g., for embedded systems, robotics, or desktop-based simulation tasks, etc.).

Referring to FIG. 9, the matrix used in this experiment is a 100×100 sparse matrix A, and reference numeral 910 shows a pattern of the matrix A. A GetMatrixL( ) function returns a lower triangular matrix L corresponding to the matrix A illustrated in reference numeral 920, and a GetMatrixU( ) function returns an upper triangular matrix U corresponding to the matrix A. A Solve( ) function outputs a result of an equation Ax=b((LL^{T})x=b).

Referring to reference numerals 910 to 920, the number of non-zero values in the matrix A is 1826, and the number of non-zero values in the triangular matrix L is 3113.

Table 1 below shows experimental results for the proposed disclosure and the GetMatrixL( ) function of the existing algorithm Eigen Sparse Library for various matrices of size 100×100. All values represent an average of 10 values (e.g., to reduce variance due to system load, cache effects, or memory allocation differences, etc.).

TABLE 1

| | | Non- | | | | |
|---|---|---|---|---|---|---|
| | Non- | Zero | | | | Performance |
| | Zero | Elem. | Proposed | Elgen(C) | P- | Improvement |
| Matrix | Elem. | In L | (P) (ms) | (ms) | C(ms) | (%) |
| A | 556 | 762 | 0.017 | 0.023 | 0.006 | 26.09 |
| B | 734 | 955 | 0.023 | 0.030 | 0.007 | 23.33 |
| C | 1356 | 1930 | 0.049 | 0.062 | 0.013 | 20.97 |
| D | 1826 | 3113 | 0.086 | 0.102 | 0.016 | 15.69 |
| E | 3828 | 3600 | 0.109 | 0.125 | 0.016 | 12.80 |
| F | 4142 | 3822 | 0.120 | 0.142 | 0.022 | 15.49 |
| G | 290 | 195 | 0.009 | 0.009 | 0 | 0.00 |
| H | 279 | 4105 | 0.119 | 0.133 | 0.014 | 10.53 |

As shown in Table 1 above, a processing speed of the GetMatrixL( ) function of the proposed disclosure provides an average performance improvement of 15.6% compared to the corresponding function in the Eigen Sparse library for all matrices.

Table 2 below shows experimental results for the proposed disclosure and the GetMatrixU( ) function function of the algorithm Eigen Sparse Library for various matrices of size 100×100. All values are an average of 10 values.

TABLE 2

| | | Non- | | | | |
|---|---|---|---|---|---|---|
| | Non- | Zero | | | | Performance |
| | Zero | Elem. | Proposed | Elgen(C) | P- | Improvement |
| Matrix | Elem. | In L | (P) (ms) | (ms) | C(ms) | (%) |
| A | 556 | 762 | 0.015 | 0.021 | 0.006 | 28.57 |
| B | 734 | 955 | 0.024 | 0.030 | 0.006 | 20.00 |
| C | 1356 | 1930 | 0.044 | 0.056 | 0.012 | 21.43 |
| D | 1826 | 3113 | 0.080 | 0.097 | 0.017 | 17.53 |
| E | 3828 | 3600 | 0.123 | 0.099 | −0.024 | −24.24 |
| F | 4142 | 3822 | 0.110 | 0.137 | 0.027 | 19.71 |
| G | 290 | 195 | 0.006 | 0.007 | 0.001 | 14.29 |
| H | 27 | 4105 | 0.109 | 0.123 | 0.014 | 11.38 |

As shown in Table 2 above, it may be seen that a processing speed of the GetMatrixU( ) function function of the proposed disclosure has an average performance improvement of 13.58% relative to the Eigen Sparse library implementation, across various matrices (e.g., matrices A-H, covering a range of sparsity levels and fill patterns, etc.).

Table 3 below shows experimental results for the proposed disclosure and the Solve( ) function of the algorithm Eigen Sparse Library for various matrices of size 100×100. All values are an average of 10 values.

TABLE 3

| | Non-Zero | Non-Zero | Proposed | |
|---|---|---|---|---|
| Matrix | Elem. | Elem. In L | (ms) | Elgen(ms) |
| A | 556 | 762 | 0.013 | 0.019 |
| B | 734 | 955 | 0.017 | 0.025 |
| C | 1356 | 1930 | 0.043 | 0.054 |
| D | 1826 | 3113 | 0.079 | 0.117 |
| E | 3828 | 3600 | 0.099 | 0.139 |
| F | 4142 | 3822 | 0.120 | 0.006 |
| G | 290 | 195 | 0.003 | 0.009 |
| H | 279 | 4105 | 0.103 | 0.121 |

As shown in Table 3 above, a processing speed of the Solve( ) function of the proposed disclosure for all matrices outperforms the Eigen Sparse livrary's Solve function, except for the matrix C, which shows a comparable or slightly worse runtime (e.g., possibly due to higher fill-in density or irregular sparsity in that matrix instance, etc.).

Table 4 below shows experimental results for the proposed disclosure and the GetMatrixU( ) function of the existing CXSparse Library for various matrices of size 100×100. All values are an average of 10 values.

TABLE 4

| | | Non- | | | | |
|---|---|---|---|---|---|---|
| | Non- | Zero | | | | Performance |
| | Zero | Elem. | Proposed | CXSparse | P- | Improvement |
| Matrix | Elem. | In L | (P) (ms) | (C)(ms) | C(ms) | (%) |
| A | 556 | 762 | 0.018 | 0.022 | 0.004 | 18.18 |
| B | 734 | 955 | 0.021 | 0.024 | 0.003 | 12.05 |
| C | 1356 | 1930 | 0.084 | 0.100 | 0.016 | 16.00 |
| D | 1826 | 3113 | 0.094 | 0.193 | 0.099 | 51.30 |
| E | 3828 | 3600 | 0.108 | 0.125 | 0.017 | 13.60 |
| F | 4142 | 3822 | 0.109 | 0.136 | 0.027 | 19.85 |
| G | 290 | 195 | 0.008 | 0.009 | 0.001 | 11.11 |
| H | 279 | 4105 | 0.130 | 0.132 | 0.002 | 1.52 |

As shown in Table 4 above, a processing speed of the GetMatrixL( ) function of the proposed disclosure provides an average performance improvement of 18.1% over the equivalent functionality provided in the CXSparse library, across different matrices (e.g., lower triangular dominance, diagonal-band structure, or random sparsity, etc.).

Table 5 below shows experimental results for the proposed disclosure and the GetMatrixU( ) function of the existing CXSparse Library for various matrices of size 100×100 with a mean value of 10.

TABLE 5

| | | Non- | | | | |
|---|---|---|---|---|---|---|
| | Non- | Zero | | | | Performance |
| | Zero | Elem. | Proposed | CXSparse | P- | Improvement |
| Matrix | Elem. | In L | (P) (ms) | (C)(ms) | C(ms) | (%) |
| A | 556 | 762 | 0.016 | 0.024 | 0.008 | 33.33 |
| B | 734 | 955 | 0.020 | 0.026 | 0.006 | 23.08 |
| C | 1356 | 1930 | 0.042 | 0.057 | 0.015 | 26.32 |
| D | 1826 | 3113 | 0.088 | 0.124 | 0.036 | 29.03 |
| E | 3828 | 3600 | 0.099 | 0.120 | 0.021 | 17.50 |
| F | 4142 | 3822 | 0.110 | 0.158 | 0.048 | 30.38 |
| G | 290 | 195 | 0.007 | 0.009 | 0.002 | 22.22 |
| H | 279 | 4105 | 0.117 | 0.128 | 0.011 | 8.59 |

As shown in Table 5 above a processing speed of the GetMatrixU( ) function of the proposed disclosure provides an average performance improvement of 23.81% when compared with the GetMatrixU( ) function of CXSparse, with matrix A showing the highest gain of 33.33%, and matrix H the lowest at 8.59%. Table 5 highlights the effectiveness of the upper triangular transpose method (e.g., particularly beneficial in matrices with clustered non-zero entries or predictable structure, etc.)

Table 6 below shows experimental results for the proposed disclosure and the Solve( ) function of the existing CXSparse Library for various matrices of size 100×100 with a mean value of 10.

TABLE 6

| | | Non- | | | | |
|---|---|---|---|---|---|---|
| | Non- | Zero | | | | Performance |
| | Zero | Elem. | Proposed | CXSparse | P- | Improvement |
| Matrix | Elem. | In L | (P) (ms) | (C)(ms) | C(ms) | (%) |
| A | 556 | 762 | 0.015 | 0.024 | 0.009 | 37.50 |
| B | 734 | 955 | 0.017 | 0.027 | 0.01 | 37.04 |
| C | 1356 | 1930 | 0.043 | 0.055 | 0.012 | 21.82 |
| D | 1826 | 3113 | 0.114 | 0.142 | 0.028 | 19.72 |
| E | 3828 | 3600 | 0.098 | 0.117 | 0.019 | 16.24 |
| F | 4142 | 3822 | 0.111 | 0.133 | 0.022 | 16.54 |
| G | 290 | 195 | 0.004 | 0.007 | 0.003 | 42.86 |
| H | 279 | 4105 | 0.122 | 0.138 | 0.016 | 11.59 |

As shown in Table 6 above, a processing speed of the Solve( ) function of the proposed disclosure provides an average performance improvement of 25.41% compared to the Solve( ) function of CXSparse across tested matrices, with the most significant improvement (42.86%) seen in matrix G. Table 6 shows the proposed method's suitability for fast, stable, and low-latency solving in time-sensitive applications (e.g., control loops in robotics, real-time optimization in autonomous systems, or embedded control for industrial machinery, etc.)

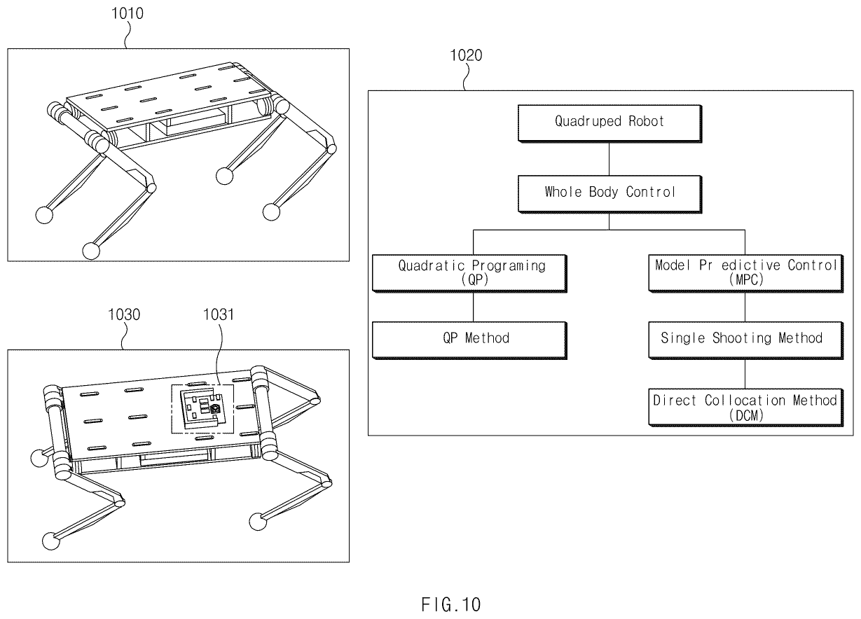

FIG. 10 shows an example of a device to which a Cholesky decomposition algorithm for a sparse matrix using an upper triangular transpose solution may be applied.

Generally, robots require a lot of computations that require high-speed processing and are usually controlled by real-time modules. Accordingly, in various applications for robot control, control loop needs to be executed in real time. For example, in robot control, a real-time module that maintains a processing time at fixed intervals (e.g., Xenomai, RT-Preempt, or RTAI, etc.) is used. The fixed interval may vary according to application, but may typically be 1 ms, 5 ms, or 10 ms.

According to the present disclosure, as shown in reference numeral 1010, it may be applied to a four-legged (quadruped) robot that requires real-time control through high-speed operation, but the present disclosure is not limited thereto, and it may be applied to various devices that require high-speed determination and control (e.g., bipedal walking robots, robotic manipulators, autonomous drones, or autonomous driving vehicle controllers, etc.).

For full body control of a quadruped robot, quadratic programming (QP) and model predictive control (MPC) may be used, as shown in reference numeral 920.

QP is a type of nonlinear programming, and may be a process for solving specific mathematical optimization problems involving quadratic functions. In particular, it may be used for a purpose of optimizing (minimizing or maximizing) a multivariate quadratic function that is subject to linear constraints on variables (e.g., joint torque limits, contact force constraints, or kinematic reachability, etc.).

MPC is a method of Optimal Control and may be widely used in planning and controlling robotics. Using MPC, dynamics such as speed, acceleration of a robot, and surrounding environmental conditions may be input using a cost function to generate an optimized control command for a situation, thereby enabling stable autonomous navigation of the robot (e.g., terrain-adaptive walking, obstacle avoidance, or dynamic balancing, etc.).

A Single Shooting Method is a core element of model predictive control (MPC), which is a method of finding a state sequence by performing a simulation in a current state. Single shooting is a direct optimal control method that discretizes a control signal and obtains system dynamics through simulation. Single shooting is a method of choice because a prediction range of the MPC is usually much shorter than a final time (e.g., for short-horizon gait optimization or low-latency motion planning, etc.).

A direct collocation method (DCM) is a technique used as an optimal control to transform an optimal control problem (OCP) into a nonlinear problem (NLP).

The Cholesky decomposition method for sparse matrices using the upper triangular transpose according to the present disclosure may be applied together with QP and MPC and utilized as an important element (e.g., computational kernel) technique for full-body control of a quadruped robot.

For example, in QP and MPC, the Cholesky decomposition method according to the proposed disclosure may be used for the purpose of optimizing an equation below.

$$f ( x ) = {x}^{T} Hx + {g}^{T} x$$

Herein, H indicates a symmetric positive definite matrix that can be solved using Cholesky decomposition, and computations for the above equations may be performed in a robot control module. For example, the robot control module may include a Raspberry Pi compute module 4 (1031) of reference numeral 1030, but this is merely one example and it may include a Beckhoff C6015, a Beckhoff C6030, NVIDIA Jetson, or STM32-based embedded controller, etc.

Hereinafter, experiment results of real-time stability and efficiency using a real robot equipped with a Cholesky decomposition algorithm will be described for the proposed disclosure and the third-party libraries.

In this experiment, Raspberry Pi compute module 4 was used as a robot control module and Xenomai 3.2 was used as a real-time module. Furthermore, an experimental time for each algorithm was set to 30 minutes, and a real-time cycle was set to 10 ms. For Cholesky decomposition, a 100×100 matrix with various sparsity patterns was applied (e.g., structured banded sparsity, random sparsity, or clustered diagonal blocks, etc.).

Table 7 below shows measurement results for average processing times and standard deviations of computing functions for the proposed disclosure and a CXSparse Library for various 100×100 matrices.

TABLE 7

| | | Non- | | | | |
|---|---|---|---|---|---|---|
| | Non- | Zero | Proposed (ms) | | Cxsparse(us) | |
| | Zero | Elem. | | Std | | Std |
| Matrix | Elem. | In L | Average | Dev. | Average | Dev. |
| A | 556 | 762 | 325.3 | 49.0 | 409.5 | 200.1 |
| B | 734 | 955 | 351.5 | 10.8 | 437.3 | 142.7 |
| C | 1356 | 1930 | 621.7 | 14.8 | 803.0 | 199.9 |
| D | 1826 | 3113 | 1011.6 | 13.7 | 1311.3 | 374.3 |
| E | 3828 | 3600 | 1189.7 | 20.2 | 1618.7 | 261.4 |
| F | 4142 | 3822 | 1329.2 | 19.9 | 1828.4 | 428.9 |
| G(No | 290 | 195 | 169.0 | 7.6 | 176.5 | 120.8 |
| Fill-ins) | | | | | | |
| H (All | 279 | 4105 | 1293.4 | 13.1 | 1637.4 | 381.8 |
| Fill-ins) | | | | | | |

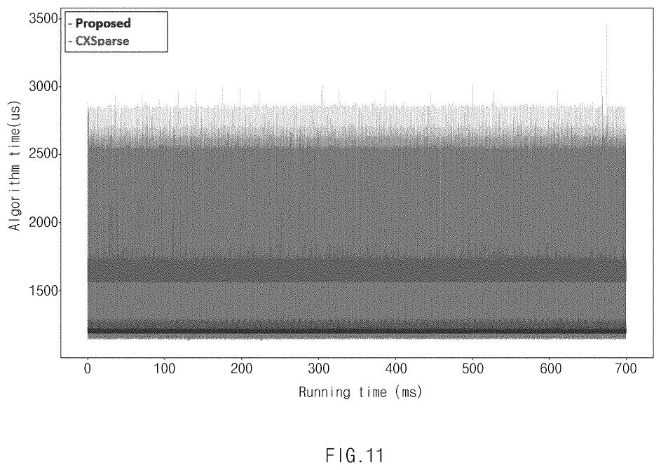

Referring to Table 7 and FIG. 11, CXSparse exhibited a reduction in control stability as its standard deviation was significantly higher than that of the proposed disclosure. Accordingly, it has a disadvantage for real-time control. In contrast, the proposed disclosure has an advantage of maintaining efficiency and stability with lower average processing time and reduced standard deviation. Thus, the proposed disclosure is more suitable for real-time applications (e.g., high-frequency locomotion control, low-latency state estimation, or trajectory tracking, etc.)

Tables 8 and 9 below show measurement results for average processing times and standard deviations for a computing function and a solve function of the proposed disclosure and the Eigen Sparse Library, respectively, for various 100×100 matrices.

TABLE 8

| | | Non- | | | | |
|---|---|---|---|---|---|---|
| | Non- | Zero | Proposed (ms) | | Elgen(us) | |
| | Zero | Elem. | | Std | | Std |
| Matrix | Elem. | In L | Average | Dev. | Average | Dev. |
| A | 556 | 762 | 280.6 | 7.8 | 240.1 | 5.4 |
| B | 734 | 955 | 315.3 | 8.0 | 294.6 | 6.0 |
| C | 1356 | 1930 | 201.4 | 9.5 | 220.3 | 6.7 |
| D | 1826 | 3113 | 924.0 | 11.3 | 1196.9 | 8.2 |
| E | 3828 | 3600 | 1115.9 | 17.3 | 1559.9 | 17.5 |
| F | 4142 | 3822 | 1239.1 | 19.6 | 1747.9 | 19.8 |
| G(No | 290 | 195 | 163.1 | 7.3 | 90.0 | 3.5 |
| Fill-ins) | | | | | | |
| H (All | 279 | 4105 | 1188.5 | 11.5 | 1587.5 | 12.7 |
| Fill-ins) | | | | | | |

TABLE 9

| | | Non- | | | | |
|---|---|---|---|---|---|---|
| | Non- | Zero | Proposed (ms) | | Elgen(us) | |
| | Zero | Elem. | | Std | | Std |
| Matrix | Elem. | In L | Average | Dev. | Average | Dev. |
| A | 556 | 762 | 201.4 | 3.8 | 220.3 | 3.2 |
| B | 734 | 955 | 237.6 | 3.6 | 261.5 | 3.0 |
| C | 1356 | 1930 | 507.5 | 4.4 | 555.8 | 4.7 |
| D | 1826 | 3113 | 685.5 | 6.2 | 1109.7 | 7.8 |
| E | 3828 | 3600 | 1075.2 | 14.1 | 1412.0 | 15.7 |
| F | 4142 | 3822 | 1205.2 | 13.4 | 1640.2 | 14.1 |
| G(No | 290 | 195 | 72.2 | 2.8 | 83.6 | 3.1 |
| Fill-ins) | | | | | | |
| H (All | 279 | 4105 | 1169.9 | 4.9 | 1456.4 | 5.5 |
| Fill-ins) | | | | | | |

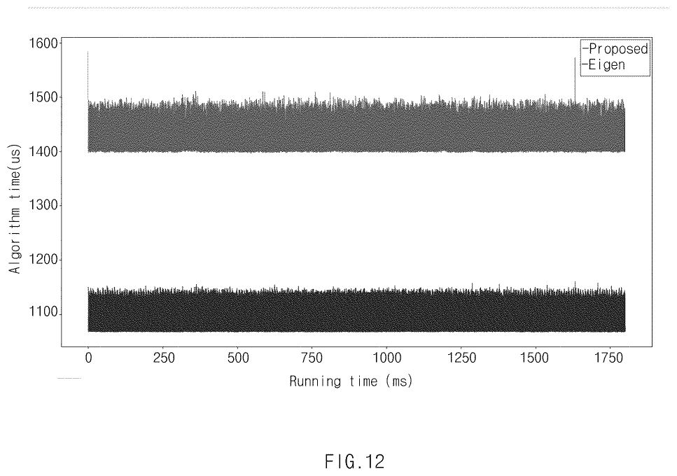

Referring to Table 8 and Table 9 and FIG. 12, Eigen shows a relatively small difference in standard deviation when compared to the proposed disclosure, but its average processing time is consistently higher than the proposed disclosure. Accordingly, Eigen's performance tends to deteriorate due to reduced matrix sparsity, resulting in a slower processing speed compared to the proposed disclosure (e.g., under high fill-in conditions or in denser motion planning scenarios, etc.).

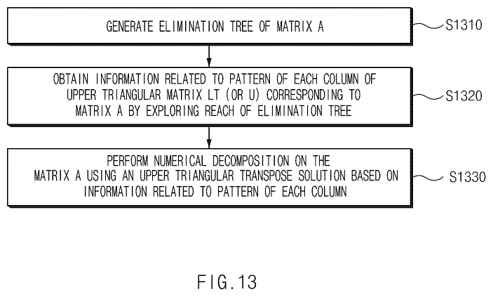

FIG. 13 shows an example Cholesky decomposition method in a computing apparatus.

A process of FIG. 13 below may be performed through a computing apparatus for a Cholesky decomposition method, and it may be understood that the operations or steps described as being performed by a system or device are controlled by a processor included in the computing apparatus (e.g., a CPU, GPU, FPGA, or embedded microcontroller, etc.).

Referring to FIG. 13, the computing apparatus may generate an elimination tree of a matrix A (S1310) (e.g., by identifying parent-child relationships based on column dependencies in the symbolic structure of A, etc.).

The computing apparatus may obtain information related to a pattern of each column of an upper triangular matrix L^{T} (or U) corresponding to the matrix A by exploring a reach of the elimination tree (S1320) (e.g., determining non-zero structure through depth-first traversal, reach sets, or sparse elimination ordering, etc.).

The computing apparatus may perform numerical decomposition on the matrix A using an upper triangular transpose solution based on the information related to the pattern of each column (S1330) (e.g., by solving U^{T}x=b, applying backward substitution, and computing values using reduced floating-point operations, etc.).

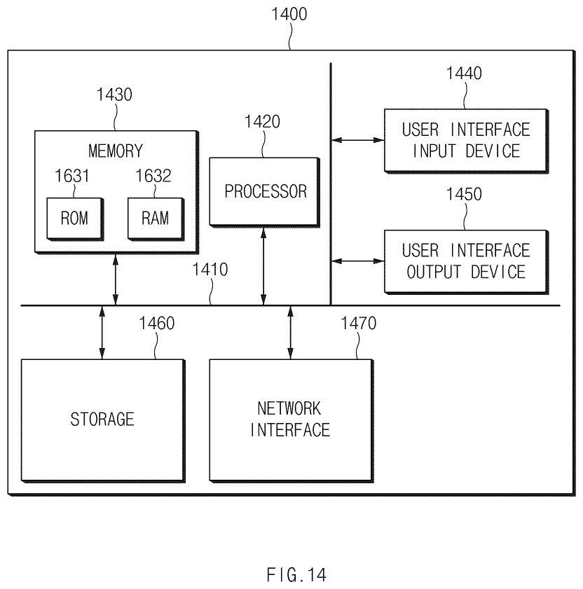

FIG. 14 shows an example computing apparatus.

Referring to FIG. 14, the computing apparatus 1400 may be configured to include at least one of at least one processor 1420 connected through a bus 1410, a memory 1430, a user interface input device 1440, a user interface output device 1450, and a storage 1460, or a network interface 1470 (e.g., Ethernet, Wi-Fi, or CAN interface, etc.).

The processor 1420 may be a central processing unit (CPU) or a semiconductor device that performs processing on commands stored in the memory 1430 and/or the storage 1460 (e.g., ARM Cortex-A72, Intel Core i5, or TI Sitara AM335x, etc.). The memory 1430 and the storage 1460 may include various types of volatile or nonvolatile storage media. For example, the memory 1430 may include a read only memory (ROM) and a random access memory (RAM) (e.g., DDR4 RAM, NOR Flash, or EEPROM, etc.).

Accordingly, steps of a method or algorithm described in connection with the examples included herein may be directly implemented by hardware, a software module, or a combination of the two, executed by the processor 1420. The software module may reside in a storage medium (i.e., the memory 1300 and/or the storage 1600) such as a RAM memory, a flash memory, a ROM memory, an EPROM memory, an EEPROM memory, a register, a hard disk, a removable disk, and a CD-ROM (e.g., microSD card, SSD, or eMMC, etc.). For example, the processor 1420 may be used for full body control of a quadruped robot, including a robot control module and a real-time module (e.g., executing QP/MPC control loops using sparse Cholesky decomposition at 1-10 ms intervals, etc.), but the present disclosure is not limited thereto.

An exemplary storage medium is coupled to the processor 1420, which can read information from and write information to the storage medium. Alternatively, the storage medium may be integrated with the processor 1420. The processor and the storage medium may reside within an application specific IC (ASIC). The ASIC may reside within a user terminal (e.g., an autonomous robot, wearable device, or real-time embedded controller, etc.). Alternatively, the processor and the storage medium may reside as separate components within the user terminal.

An example of the present disclosure attempts to provide a Cholesky decomposition method for a sparse matrix using an upper triangular transpose solution and a device using the same.

Another example of the present disclosure attempts to provide a real-time computing apparatus including a robot controller to which a Cholesky decomposition method for a sparse matrix using an upper triangular transpose solution is applied.

An example of the present disclosure attempts to provide a Cholesky decomposition technique for sparse matrices using an upper triangular transpose solution that may be installed in heterogeneous devices and/or systems.

The technical objects of the present disclosure are not limited to the objects mentioned above, and other technical objects not mentioned may be clearly understood by those skilled in the art from the description of the claims.

An example of the present disclosure provides a Cholesky decomposition method in an computing apparatus, the method including generating, by a processor, an elimination tree of a sparse matrix A, obtaining, by the processor, information related to a pattern of each column of an upper triangular matrix L^{T} (or U) corresponding to the matrix A by exploring a reach of the elimination tree, and performing, by the processor, numerical decomposition on the sparse matrix A using an upper triangular transpose solution based on the information related to the pattern of each column.

According to an example, the information related to the pattern of each column may include a column pointer and a row index.

According to an example, each column value of the upper triangular matrix L^{T} (or U) may be computed to generate the L^{T} (or U) through the numerical decomposition.

According to an example, the upper triangular transpose solution may include receiving, by the processor, a dense vector b corresponding to the sparse matrix A, and generating, by the processor, a transpose matrix U^{T} of the U, and the vector x may be computed by applying the dense vector b and the U^{T} to an equation U^{T}x=b.

According to an example, the performing of the numerical decomposition further includes computing, by the processor, diagonal component values of the triangular matrix U, and the diagonal component value of the triangular matrix U may be computed based on the diagonal component values of the sparse matrix A and the computed vector x.

According to an example, the upper triangular matrix U may be generated using the computed vector x and the computed diagonal component values.

According to an example, the reach of the elimination tree may be obtained by searching for non-zero elements of the sparse matrix A.

According to an example, the sparse matrix A may be a n×n symmetric positive definite matrix, and n may be a natural number n×n.

According to an example, the computing apparatus may include a robot control module, and the Cholesky decomposition method is installed in the robot control module together with a quadratic programming (QP) method and a model predictive control (MPC) method for controlling an entire body of the robot.

According to an example, the computing apparatus may be a device equipped with a real-time module that maintains a processing time at fixed intervals.

Another example of the present disclosure provides a computing apparatus including a processor configured to execute commands, and a memory to configured to store the commands, and the commands may be implemented to perform numerical decomposition on a sparse matrix A by generating an elimination tree of the sparse matrix A, obtaining information related to a pattern of each column of an upper triangular matrix L^{T} (or U) corresponding to the matrix A by exploring the reach of the elimination tree, and using an upper triangular transpose solution based on the information related to the pattern of each column.

According to an example, the information related to the pattern of each column may include a column pointer and a row index.

According to an example, each column value of the upper triangular matrix L^{T} (or U) may be computed to generate the L^{T} (or U) through the numerical decomposition.

According to an example, the upper triangular transpose solution may be implemented which accepts a dense vector b corresponding to the sparse matrix A and generate a transpose matrix U^{T} of the U, and the process is configured to compute the vector x by applying the dense vector b and the U^{T} to an equation U^{T}x=b.

The commands may be implemented to compute a diagonal component value of the upper triangular matrix U, and the processor is configured to compute the diagonal component value of the upper triangular matrix U based on a diagonal component value of the sparse matrix A and the computed vector x.

According to an example, the processor may be configured to generate the upper triangular matrix U using the computed vector x and the computed diagonal component values.

According to an example, the reach may be obtained by searching for non-zero elements of the sparse matrix A.

According to an example, the sparse matrix A may be a n×n symmetric positive definite matrix, and n may be a natural number n×n.

According to an example, the processor may be configured to further include a robot control module, and the processor may be configured to perform full body control of a quadruped robot by executing the commands.

According to an example, the processor may be configured to further include a real-time module that maintains a processing time at fixed intervals.

The present technique has a merit of providing a Cholesky decomposition method for a sparse matrix using an upper triangular transpose solution and a device using the same.

Furthermore, the present technique has a merit of providing a real-time computing apparatus including a robot controller to which a Cholesky decomposition method for a sparse matrix using an upper triangular transpose solution is applied.

Furthermore, the present technique has a merit of reducing computational complexity and saving computing power compared to the related art by eliminating a column count determination procedure of the related art lower triangular matrix by applying an upper triangular transpose solution method in Cholesky decomposition of a sparse matrix.

Furthermore, the present technique has a merit of enabling more accurate analysis and stable control in real-time computing environments such as robot controllers.

Furthermore, various effects which may be directly or indirectly identified through the present specification may be provided.

The above description is merely illustrative of the technical idea of the present disclosure, and those skilled in the art to which the present disclosure pertains may make various modifications and variations without departing from the essential characteristics of the present disclosure.

Therefore, the examples disclosed in the present disclosure are not intended to limit the technical ideas of the present disclosure, but to explain them, and the scope of the technical ideas of the present disclosure is not limited by these examples. The protection range of the present disclosure should be interpreted by the claims below, and all technical ideas within the equivalent range should be interpreted as being included in the scope of the present disclosure.

What is claimed:

1. A method performed by an apparatus of a robot, the method comprising:
generating an elimination tree of a sparse matrix associated with an autonomous movement operation of the robot;
obtaining information related to a pattern of each column of an upper triangular matrix corresponding to the sparse matrix by exploring a reach of the elimination tree;
performing, based on the information related to the pattern of each column, numerical decomposition on the sparse matrix using an upper triangular transpose solution;
outputting, based on the numerical decomposition on the sparse matrix, a signal; and
controlling, based on the signal, the autonomous movement operation of the robot.

2. The method of claim 1, wherein the information related to the pattern of each column comprises a column pointer and a row index, wherein the column pointer indicates a starting position of non-zero elements for each column within the upper triangular matrix, and wherein the row index identifies row positions corresponding to the non-zero elements of the upper triangular matrix.

3. The method of claim 1, wherein each column value of the upper triangular matrix is determined to generate the upper triangular matrix through the numerical decomposition.

4. The method of claim 3, wherein the using the upper triangular transpose solution comprises:
receiving a dense vector corresponding to the sparse matrix; and
generating a transpose matrix of the upper triangular matrix, wherein the dense vector is a product of the transpose matrix and another vector.

5. The method of claim 4, wherein the performing of the numerical decomposition comprises determining diagonal component values of the upper triangular matrix,
wherein the diagonal component values of the upper triangular matrix are determined based on diagonal component values of the sparse matrix and the other vector.

6. The method of claim 5, wherein the upper triangular matrix is generated using the other vector and the diagonal component values of the upper triangular matrix.

7. The method of claim 1, wherein the reach is obtained by searching for non-zero elements of the sparse matrix.

8. The method of claim 1, wherein the sparse matrix is a n×n symmetric positive definite matrix, and wherein n is a natural number.

9. An apparatus comprising:
a processor; and
a memory storing at least one instruction that, when executed by the processor communicating with the memory, is configured to cause the apparatus to:
generate an elimination tree of a sparse matrix associated with an autonomous movement operation of a robot;
obtain information related to a pattern of each column of an upper triangular matrix corresponding to the sparse matrix by exploring a reach of the elimination tree;
perform, based on the information related to the pattern of each column, numerical decomposition on the sparse matrix using an upper triangular transpose solution;
output, based on the numerical decomposition on the sparse matrix, a signal; and
control, based on the signal, the autonomous movement operation of the robot.

10. The apparatus of claim 9, wherein the information related to the pattern of each column comprises a column pointer and a row index, wherein the column pointer indicates a starting position of non-zero elements for each column within the upper triangular matrix, and wherein the row index identifies row positions corresponding to the non-zero elements of the upper triangular matrix.

11. The apparatus of claim 9, wherein each column value of the upper triangular matrix is determined to generate the upper triangular matrix through the numerical decomposition.

12. The apparatus of claim 9, wherein the at least one instruction, when executed by the processor communicating with the memory, is configured to cause the apparatus to explore the reach of the elimination tree by searching for non-zero elements of the sparse matrix.

13. The apparatus of claim 9, wherein the sparse matrix is a n×n symmetric positive definite matrix, and wherein n is a natural number.

14. The apparatus of claim 9, wherein the at least one instruction, when executed by the processor communicating with the memory, is configured to cause the apparatus to control the autonomous movement operation of the robot, wherein the robot is a quadruped robot, and wherein the control involves performing control of four legs of the quadruped robot.

15. The apparatus of claim 9, wherein the at least one instruction, when executed by the processor communicating with the memory, is configured to cause the apparatus to maintain a processing time for the controlling the operation of the robot at fixed intervals.

16. An apparatus for controlling a vehicle, the apparatus comprising:
a processor; and
a memory storing at least one instruction that, when executed by the processor communicating with the memory, is configured to cause the apparatus to:
generate an elimination tree of a sparse matrix associated with an autonomous movement operation of the vehicle;
determine pattern information for each column of an upper triangular matrix corresponding to the sparse matrix by performing a dependency path traversal of the elimination tree;
perform, based on the pattern information, numerical factorization of the sparse matrix using an upper triangular transpose solution;
generate, based on the numerical factorization, a signal; and
control, based on the signal, the autonomous movement operation of the vehicle.

17. The apparatus of claim 16, wherein the signal is generated and applied within a fixed-time interval of 10 milliseconds or less to enable real-time control of the autonomous movement operation of the vehicle.

18. The apparatus of claim 16, wherein the at least one instruction, when executed by the processor communicating with the memory, is configured to cause the apparatus to generate the signal based on one or more sensor inputs from the vehicle, wherein the signal is configured to enable control of the vehicle.

19. The apparatus of claim 16, wherein the sparse matrix is a symmetric positive definite matrix that represents a control problem formulated using one of a model predictive control framework or a quadratic programming problem for control of the vehicle.

20. The apparatus of claim 16, wherein performing the dependency path traversal of the elimination tree comprises:
identifying a set of nodes in the elimination tree corresponding to non-zero entries in a column of the sparse matrix; and
traversing upward from the identified set of nodes in the elimination tree to obtain ancestor nodes that represent dependencies for determining a non-zero pattern in a corresponding column of the upper triangular matrix.
